(19) United States
(12) Patent Application Publication
(10) Pub. No.: US 2025/0050171 A1
(43) Pub. Date: Feb. 13, 2025

(54) Exercise System

(71) Applicant: ShapeLog, Inc., Ann Arbor, MI (US)

(72) Inventors: Nolan Orfield, Ann Arbor, MI (US); Bryan O'Rear, Wilmette, IL (US); Mark Angeloni, Ann Arbor, MI (US); Andrew Muth, Westford, VT (US); Eric Herrera, Chicago, IL (US)

(73) Assignee: ShapeLog, Inc., Ann Arbor, MI (US)

(21) Appl. No.: 18/744,011

(22) Filed: Jun. 14, 2024

Related U.S. Application Data
(60) Provisional application No. 63/508,262, filed on Jun. 14, 2023.

(51) Int. Cl. A63B 24/00; A63B 21/00; A63B 21/068

(52) U.S. Cl. CPC A63B 24/0062; A63B 21/068; A63B 21/4031; A63B 21/4045; A63B 2220/13; A63B 2220/18; A63B 2220/805; A63B 2220/833; A63B 2230/01

(57) ABSTRACT

An exercise system includes an exercise machine and a sensor system. The exercise machine includes a chassis and a sliding platform. The chassis defines an incline. The sliding platform is configured to support a user thereon and translates along the incline. The exercise machine is configured for the user to perform resistance exercises therewith. The sensor system includes a position sensor that measures a position of the sliding platform relative to the chassis.

### CROSS-REFERENCE TO RELATED APPLICATION(S)

This application claims priority to and the benefit of U.S. Provisional Application No. 63/508,262, filed Jun. 14, 2023, the entire disclosure of which is incorporated by reference herein.

### TECHNICAL FIELD

This disclosure relates to exercise systems and, in particular, exercise systems that monitor exercises performed by users.

### BACKGROUND

Exercise machines may use weight of the user as a primary means of resistance of resistance exercises. It would be advantageous to provide exercise systems that automatically track and determine performance characteristics of the resistance exercise with such exercise machines.

### SUMMARY

Disclosed herein are implementations of exercise systems. In an implementation, an exercise system includes an exercise machine and a sensor system. The exercise machine includes a chassis and a sliding platform. The chassis defines an incline. The sliding platform is configured to support a user thereon and translates along the incline. The exercise machine is configured for the user to perform resistance exercises therewith. The sensor system includes a position sensor that measures a position of the sliding platform relative to the chassis.

One of the sensor system or a computer system in communication with the sensor system may be configured to determine, according to the position measured by the position sensor over time, a number of repetitions of a set of one of the resistance exercises performed by the user. The position sensor may be a LIDAR sensor. The chassis may include a rail structure that defines the incline and includes a lower end that is configured to be supported by a ground level. The LIDAR sensor may be coupled to the sliding platform and measures the position of the sliding platform by measuring a distance between the LIDAR sensor and the lower end of the rail structure. Inclination of the incline may be adjustable relative to gravity. The sensor system may further include an inclination sensor configured to determine the inclination of the incline. The inclination sensor may be an accelerometer. The sensor system may include a sensor system module having a housing containing the position sensor and the inclination sensor. The exercise system may further include a computer system that is configured to determine resistance of the resistance exercises performed by the user according to the inclination determined by the inclination sensor, a first weight of the sliding platform, and a second weight of the user. The sliding platform may include rollers that roll along the incline for the sliding platform to translate along the incline.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic view of an exercise system.

FIG. 2 is a side view of an exercise machine of the exercise system of FIG. 1.

FIG. 3 is a front view of the exercise machine of FIG. 2.

FIG. 4 is a partial top view of the exercise machine of FIG. 2 with hidden components depicted in dashed lines.

FIG. 5 is a partial side view of the exercise machine of FIG. 2 with hidden components depicted in dashed lines.

FIG. 6 is a schematic view of a sensor system of the exercise system of FIG. 1.

FIG. 7 is a schematic view of an example hardware configuration of a controller of the sensor system.

FIG. 8 is a partial top view of the exercise machine of FIG. 2 with hidden components depicted in dashed lines and a sensor system module in a first mounting configuration.

FIG. 8A is a partial side view of one model of the exercise machine of FIG. 2 with the sensor system module coupled thereto.

FIG. 8B is a partial side view of another model of the exercise machine of FIG. 2 having a different geometry than exercise machine of FIG. 2 with the sensor system module coupled thereto.

FIG. 9 is a partial top view of the exercise machine of FIG. 2 with hidden components depicted in dashed lines and a sensor system module in a second mounting configuration.

FIG. 10 is a partial top view of the exercise machine of FIG. 2 with hidden components depicted in dashed lines and a sensor system module in a third mounting configuration.

FIG. 11 is a partial side view of the exercise machine of FIG. 2 with another embodiment of the sensor system module in a fourth mounting configuration.

FIG. 12 is a partial side view of the exercise machine of FIG. 2 with another embodiment of the sensor system module in a fifth mounting configuration.

FIG. 13 is a schematic view of the computing system 170 of the exercise system of FIG. 1.

FIG. 14 is a schematic of information capture, flow, and processing performed by the exercise system.

### DETAILED DESCRIPTION

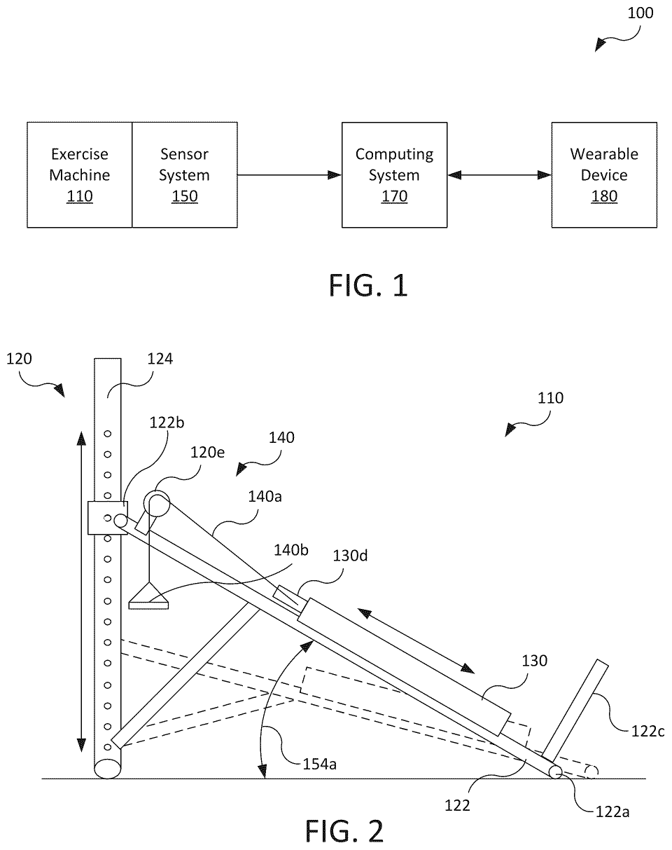

Referring to FIG. 1, an exercise system 100 includes an exercise machine 110, a sensor system 150, and a computing system 170, and may further include a wearable device 180. Some embodiments of the exercise system 100 may include more than one of the exercise machine 110, the sensor system 150, the computing system 170, the wearable device 180, or combinations thereof.

The exercise machine 110 is configured for a user to perform resistance exercises therewith. More particularly, and as discussed in further detail below, the exercise machine 110 is configured for the user to move themselves along an incline of selectable angle relative to gravity, whereby the weight of the user forms the resistance for the resistance exercises performed by the user. The sensor system 150 is configured to detect various information about the exercise machine 110, which may be referred to as sensor information, such as position and/or movement and inclination (e.g., angle of inclination 154a) of the exercise machine 110 during performance of exercises by users with the exercise machine 110. The computing system 170 receives the sensor information about the exercise machine 110, other information derived therefrom, from the sensor system 150 and from which further information describing or quantifying the exercise (e.g., exercise information) being performed by the user may be determined. Exercise information may, for example, include the number of repetitions, inclination, and resistance of a set of repetitions, identifying the exercise being performed, duration of a set or workout of multiple sets, work performed during a set or workout of multiple sets, calories burned during a set or workout of multiple sets, other information, or combinations thereof.

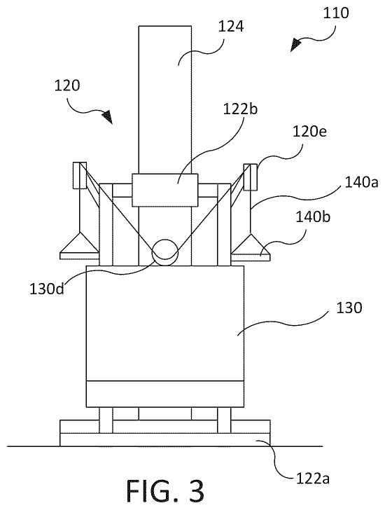

Referring to FIGS. 2-3, the exercise machine 110 is configured for a user to perform various resistance exercises by which the weight of the user provides resistance. More particularly, the exercise machine 110 generally includes a chassis 120, a sliding platform 130, and a handle system 140. The exercise machine 110 is configured such that, as the user is positioned on the sliding platform 130 and pulls on the handle system 140, the sliding platform 130 and the user thereon are pulled by the user up an incline defined by the chassis 120. That is, during performance of exercises, the user pulls themselves relative to the chassis 120 such that the sliding platform 130 translates along the incline of the chassis 120.

The chassis 120 generally includes a rail structure 122 and an upright support 124 that supports the rail structure 122 above a ground level (e.g., a floor of a building). The rail structure 122 is elongated and defines a track along which the sliding platform 130 translates (e.g., slides) back and forth in a predetermined path, such as a linear path. The rail structure 122 generally includes a lower end 122a and an upper end 122b. The lower end 122a of the rail structure 122 is configured to rest on and be supported by the ground level. The upper end 122b is configured to be elevated by the upright support 124 at one or more elevations above the ground level, such that the rail structure 122 forms an incline.

The upright support 124 is configured, as referenced above, to elevate the upper end 122b of the rail structure 122 above the ground level. In one embodiment, the upright support 124 is a generally vertical structure that rests on and is supported by the ground level. The upper end 122b of the rail structure 122 is configured to couple to and be supported by the upright support 124 at different selectable locations therealong, so as to be supported by the upright support 124 at discrete elevations. For example, the upright support 124 may slide within the upper end of the rail structure 122 (e.g., being configured as male and female structures), while a retractable pin fixed to the rail structure 122 is receivable within apertures (depicted, not labeled) of the upright support 124. The retractable pin thereby couples the upper end 122b of the rail structure 122 to the upright support 124 at the different elevations to be supported thereby. Each of the different discrete elevations at which the rail structure 122 is coupled to the upright support 124 may be referred to as a setting, such as an elevation or inclination setting. In another embodiment, the upright support 124 is configured to support the rail structure 122 from a midpoint thereof, for example, being pivotable relative thereto.

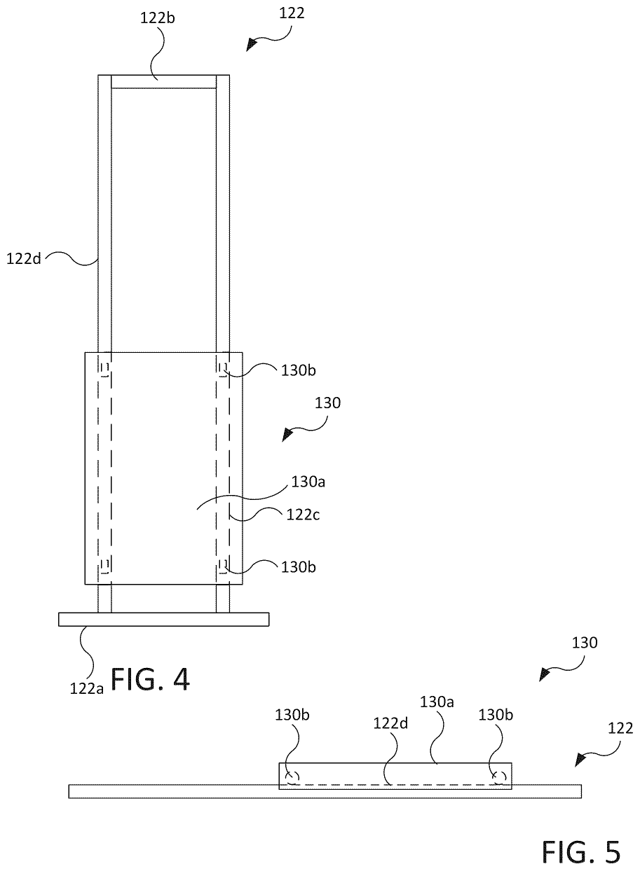

Referring additionally to FIGS. 4-5, the chassis 120 and the sliding platform 130 are cooperatively configured for the sliding platform 130 to slide along the rail structure 122 of the chassis 120 up and down the incline formed thereby. For example, the rail structure 122 includes rails 122c, 122d, while the sliding platform 130 includes a base 130a and rollers 130b that support and/or guide the base 130a along the rail structure 122. The base 130a may, for example, provide a generally planar upper surface (e.g., formed by a board) or a contoured upper surface (e.g., a seat). The base 130a may include a frame below the upper surface to which the rollers 130b are coupled.

The rails 122c, 122d of the rail structure 122 may be referred to as a first rail 122c and a second rail 122d. The first rail 122c and the second rail 122d are elongated and spaced apart, extending substantially parallel to each other, for example, from or proximate to the lower end 122a of the rail structure 122 to or proximate the upper end 122b thereof. In one example, the first rail 122c and the second rail 122d are rectangular in cross-section, or may alternatively be circular or otherwise rounded in cross-section). The first rail 122c and the second rail 122d each define upper surfaces (e.g., planar surfaces) that are parallel and coplanar with each other. The first rail 122c and the second rail 122d each further define lateral surfaces (e.g., inward or outward surfaces) that are parallel with each other and at least partially opposed to each other.

The rollers 130b of the sliding platform 130 are coupled to and arranged below the base 130a (e.g., being coupled to a frame below the base 130a) and roll along the upper surfaces of the first rail 122c and the second rail 122d to support the base 130a thereabove, such that the sliding platform 130 slides or otherwise translates along the rail structure 122. The rail structure 122 may further include guides (e.g., slides or rollers; not shown) that are coupled to and arranged below the base 130a and slide along or adjacent to the lateral surfaces of the first rail 122c and the second rail 122d to guide the base 130a along the first rail 122c and the second rail 122d in a linear path with the rollers 130b maintained on the upper surfaces thereof.

Referring again to FIGS. 2-3, the handle system 140 is configured to be pulled by the user to move themselves on the sliding platform 130 along the rail structure 122. In one example, the handle system 140 includes a cable 140a having two ends and two handles 140b, each of the handles 140b being coupled to one of the ends of the cable 140a. The cable 140a is further engaged and coupled to each of the chassis 120 and the sliding platform 130. In one example, the cable 140a extends inward from the each of the handles 140b, to the chassis 120, and finally to the sliding platform 130. For example, two sides of the cable 140a that each extend inward from one of the two handles 140b extend through one of two pulleys 120e coupled to left and right sides of the upper end 122b of the rail structure 122, while a central portion of the cable 140a extends through a third pulley 130d coupled to an upper end of the sliding platform 130. As the user pulls on the handles 140b, the cable 140a comes into tension therebetween and pulls the sliding platform 130 upward along the incline formed by the chassis 120.

The user may perform different resistance exercises by orienting their body in different positions and moving their arms in different manners relative to the chassis 120. In one exemplary exercise, seated on the sliding platform 130, elbows down at their side, and one of the handles 140b in each hand, the user may perform bicep curls. As the user curls and uncurls one or both arms, the cable 140a comes into tension through the pulleys 120e of the chassis 120, thereby pulling on the sliding platform 130 to raise and lower the sliding platform 130 and the user thereon along the incline formed by the rail structure 122 of the chassis 120. In another exemplary exercise, seated on the sliding platform 130, elbows at shoulder level, and one of the handles 140b in each hand, the user may perform a chest press. As the user presses their hands outward from and retracts their hands toward their chest, the cable 140a comes into tension through the pulleys 120e of the chassis 120, thereby pulling on the sliding platform 130 to raise and lower the sliding platform 130 and the user thereon along the incline formed by the rail structure of the chassis 120. In a still further example, the user may perform exercises without the handle system 140, for example, by pressing their legs against a stationary platform 122e (e.g., a foot or kick plate). The stationary platform 122e is coupled to the rail structure 122 proximate the lower end 122a and below the sliding platform 130 and extends upward therefrom substantially perpendicular to the angle of inclination 154a.

In order to change the amount of resistance being performed during an exercise, the user may change the elevation of the upper end 122b of the rail structure 122 to change the angle of inclination 154a of the rail structure 122. For example, the user may raise the upper end 122b of the rail structure 122, which in turn increases the angle of inclination 154a of the rail structure 122 along which the sliding platform 130 and the user move, thereby increasing the amount of resistance for a given exercise. The user may instead lower the upper end 122b of the rail structure 122, which in turn decreases the angle of inclination 154a of the rail structure 122 along which the sliding platform and the user move, thereby decreasing the amount of resistance for a given exercise.

The sensor system 150 is configured to detect information about the exercise machine 110 (e.g., machine information) from which information may be determined for one or more resistance exercises performed by the user (e.g., exercise information). More particularly, the sensor system 150 is configured to detect a position of the sliding platform 130 along the rail structure 122 of the chassis 120 as it moves over time (e.g., position information), inclination of the rail structure 122 of the chassis 120 (e.g., inclination information), or both. The sensor system 150 may be further configured to determine exercise information from the position information and the inclination information. The sensor system 150 is still further configured to transmit the position information, the inclination information, the other information derived therefrom, or combinations thereof. For example, the sensor system 150 may be configured to send signals with the position information, the inclination information, or other information derived therefrom to the computing system 170.

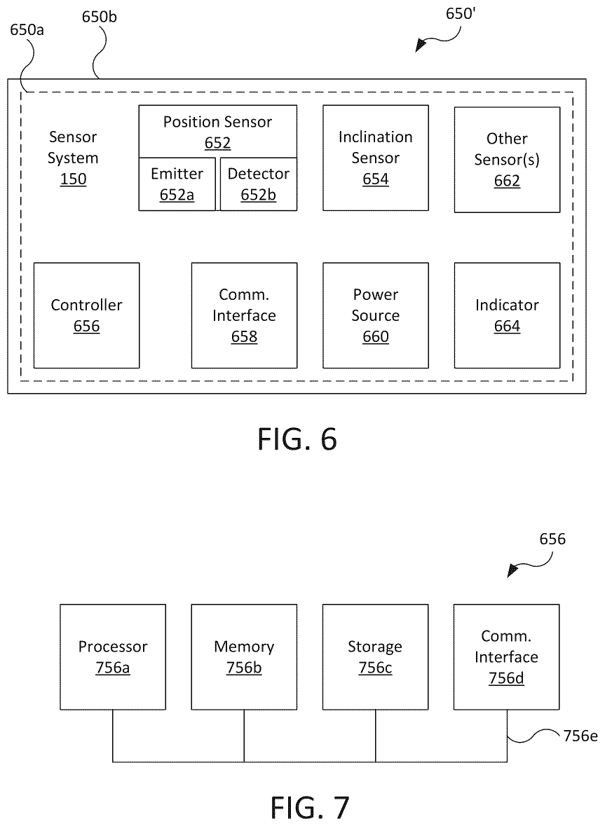

Referring to FIG. 6, in one example, the sensor system 150 includes a position sensor 652, an inclination sensor 654, a controller 656, a communications interface 658, and a power source 660. The sensor system 150 may be provided as a sensor module 650′, which is a singular unit having a chassis 650a (e.g., a circuit board) to which the other electronic components are coupled and a housing 650b in which the chassis 650a and the electronic components are contained. The sensor system 150 may, instead of or in addition to the position sensor 652 and the inclination sensor 654 include one or more other sensors 662, such as accelerometers, force sensors, or combinations thereof. The sensor system 150 may further include indicators 664 (e.g., lights or speakers) that communicate various information to users (e.g., connection to the computing system 170, state of the power source 660).

The position sensor 652 is configured to measure or otherwise determine the position of the sliding platform 130 along the rail structure 122 of the chassis 120. The sensor system 150 is further configured to transmit the position information (e.g., the position of the sliding platform 130 over time), for example, with the communications interface 658 as operated by the controller 656 to the computing system 170. Instead of or in addition to the position information, the sensor system 150 may be configured to determine other information from the position information (e.g., repetition information, as discussed below) and transmit the other information, for example, to the computing system 170. Various configurations of the position sensor 652 are discussed in further detail below.

The inclination sensor 654 is configured to measure or otherwise determine the angle of inclination 154a or inclination setting of the rail structure 122 of the chassis 120, the sliding platform 130, or both. For example, the inclination sensor 654 may measure an angle of the rail structure 122 or the sliding platform 130 relative to gravity. Alternatively, the inclination sensor 654 may detect which of the discrete elevations (e.g., positions) at which the rail structure 122 is supported by the upright support 124. The sensor system 150 is further configured to send the inclination information (e.g., the angle or the discrete position), for example, with the communications interface 658 as operated by the controller 656 to the computing system 170. Various configurations and aspects of the inclination sensor 654 are discussed in further detail

The controller 656 is configured to operate the various electronic components of the sensor system 150, including the position sensor 652, the inclination sensor 654, and the communications interface 658, as well as the other sensors 662 and the indicators 664 (if included). The controller 656 may be further configured to determine various information according to the position information, the inclination information, or both, for example, various exercise information from the position information, such as repetitions (as discussed in further detail below) and an inclination setting from the angle of inclination 154a.

Referring additionally to FIG. 7, the controller 656 is configured to perform various operations, as described herein, such as receiving, processing, and/or transmitting the position information, the inclination information, or other information derived therefrom. In one non-limiting example, the controller 656 may have a hardware configuration that generally includes a processor 756a, a memory 756b, a storage 756c, a communications interface 756d, and a bus 756e by which the other components of the controller 656 are in communication with each other. The processor 756a may, for example, be a central processing unit (CPU) or other processing device capable of executing written instructions (e.g., software). The memory 756b is a volatile storage device, such as a random access memory (RAM) module. The Storage 756c is a non-volatile storage device, such as a hard disc or solid state drive or device (e.g., HDD, or SSD). The communications interface 756d is configured to receive and transmit signals to and/from the controller 656 in any suitable manner. The controller 656 may have any other suitable hardware configuration.

The communications interface 658 is configured to transmit the position information, the inclination information, or other information derived therefrom, for example, to the computing system 170. The communications interface 658 may include any suitable hardware (e.g., modems, radios) and use any suitable wired or wireless communications protocol, such as Bluetooth Low Energy (BLE), ANT, or Wi-Fi.

The power source 660 is configured to provide power for operating the other electronic components of the sensor system 150. In one example, the power source 660 includes a battery, such as a primary battery (i.e., non-rechargeable) that is removable and replaceable with respect to the sensor system module 650′ or a rechargeable battery (i.e., secondary) that may be removable or irremovable from the sensor system module 650′. Alternatively, the power source 660 includes a cord and plug by which the sensor system 150 receives power from a wired connection (e.g., of a building). The power source 660 may be considered to include other hardware components suitable for conditioning and transferring power to the other electronic components of the sensor system 150 for operation thereof.

Referring to FIG. 6, the position sensor 652 is configured to detect the position of the sliding platform 130 relative to the chassis 120, for example, relative to the rail structure 122 or the upright support 124. As discussed in further detail below, the position of the sliding platform 130 at different times, including the velocity and acceleration thereof, may be used, alone or in conjunction with other known or sensed information, to determine various characteristics of exercises being performed by the user. For example, the position information collected over time may be used alone to determine various exercise characteristics (e.g., number, cadence, and distance of repetitions in a set of repetitions). In other examples, the position data may be used in conjunction with other sensor information (e.g., angle of inclination 154a) and known data (e.g., user weight) to determine other exercise characteristics (e.g., weight, work, and power of each repetition or a set of repetitions).

In one example, the positon sensor 652 includes an emitter 652a and a detector 652b, such as an emitter and detector used in light detection and ranging (LiDAR) or sound navigation and ranging (SONAR). In the case of the position sensor 652 being a LIDAR sensor, the sensor system 150 may further include a reflector 852c. The reflector 852c may, for example, include a retroreflective or other suitable reflective material. The reflector 852c is coupled to the exercise machine 110 in any suitable manner, such as being configured as a sticker that is applied to another structure of the exercise machine 110 (e.g., the lower end 122a of the chassis 122, which may be configured as a rounded bar or tube) or being coupled to another structure that is in turn coupled to the exercise machine 110 (e.g., as shown).

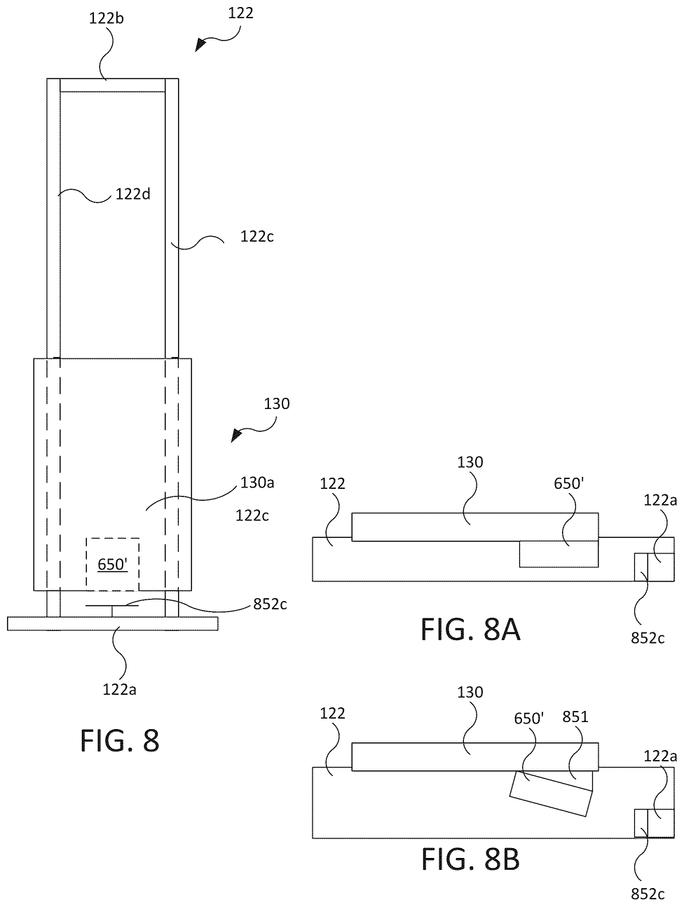

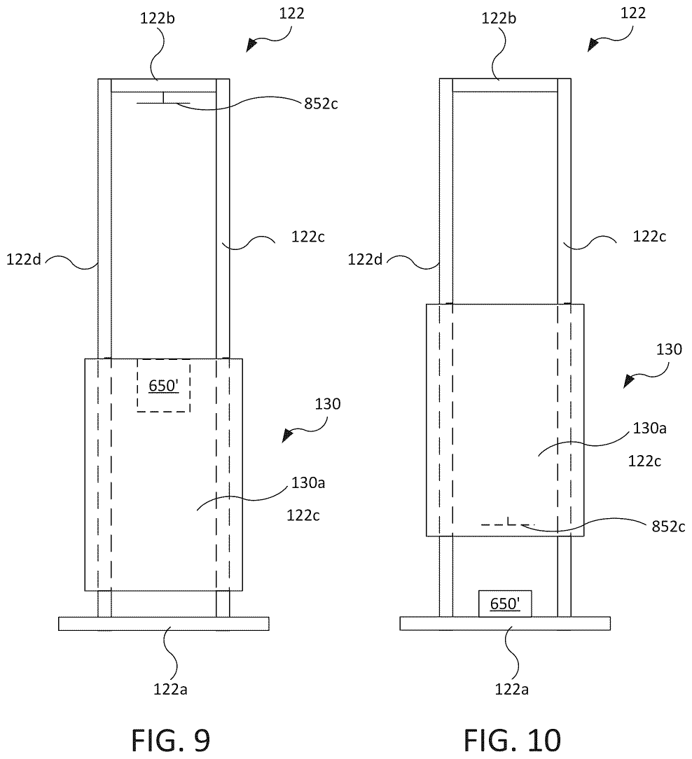

In the embodiment shown in FIG. 8, the sensor module 650′ is coupled to a bottom end of the sliding platform 130 with the position sensor 652 (e.g., the emitter 652a and the detector 652b) oriented toward the reflector 852c coupled to the bottom end 122a of the rail structure 122 of the chassis 120. The emitter 652a emits light (e.g., infrared electromagnetic radiation) toward the reflector 852c, the reflector reflects the light back toward the detector 652b, and the detector 652b detects the light reflected by the reflector 852c to determine the position of the sliding platform 130 relative to the rail structure 122 of the chassis 120, for example, using time of flight calculations. In the embodiment shown in FIG. 9, the sensor module 150′ is coupled to an upper end of the sliding platform 130 with the position sensor 652 oriented toward the reflector 852c coupled to the upper end 122b of the rail structure 122 or, alternatively, to the upright support 124. In the embodiment shown in FIG. 10, the sensor module 150′ is coupled to the lower end 122a of the rail structure 122 with the sensor 652 oriented toward the reflector 852c coupled to the sliding platform 130 (e.g., to the lower end thereof, the underside thereof, or both). Mounting of the sensor module 650′ to the exercise machine 110 is discussed in further detail below.

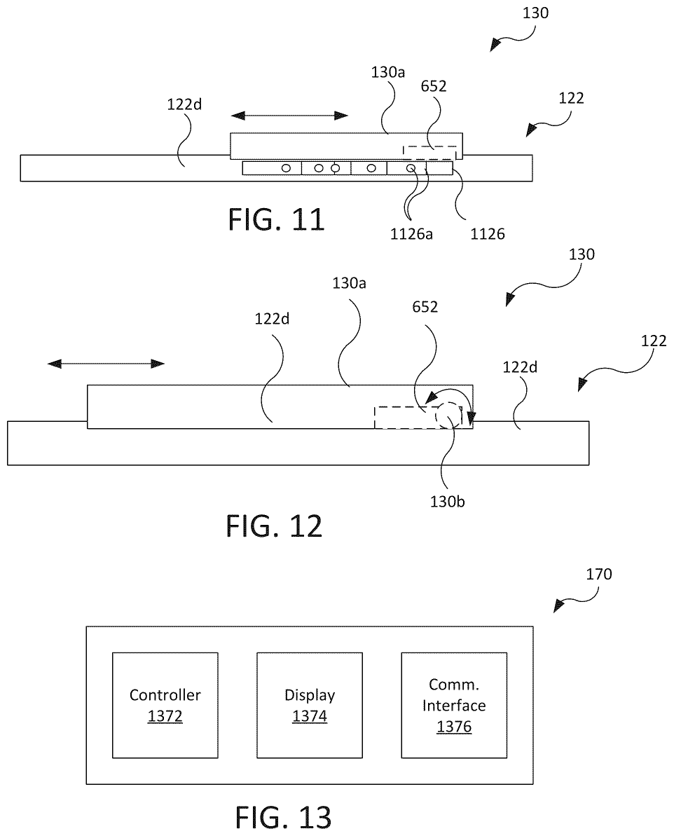

Referring to FIG. 11, the position sensor 652 may be configured as a reader coupled to the sliding platform 130, while the chassis 120 (e.g., the rail structure 122) includes a target 1126 coupled thereto. The target 1126 includes indicia 1126a that are readable by the position sensor 652 the position sensor 652 as the sliding platform 130 and the position sensor 652 move therepast and which indicate the position along the rail structure 122. In one example, the position sensor 652 is an optical reader (e.g., camera or laser-based) and the target 1126 includes indicia 1126a that are optically-readable to indicate the position along the rail structure 122 (e.g., indicia, such as lines or other shapes, having contrasting color to a background). In another example, the position sensor 652 is a magnetic reader (e.g., Hall sensor) and the target 1126 includes indicia that are magnetically-readable to indicate the position along the rail structure 122 (e.g., magnets or ferromagnetic material of different patterns and/or strength).

Referring to FIG. 12, the position sensor 652 is a rotational sensor (e.g., Hall sensor) that is configured sense rotation of one of the rollers 130b along the rail structure 122 to determine the position (or changes therein) of the sliding platform 130 relative to the rail structure 122 (e.g., based on a known diameter of the roller 130b).

Referring again to FIGS. 2 and 6, the inclination sensor 654 is configured to detect the angle of inclination 154a of the rail structure 122 relative to ground level or gravity, which is the angle of inclination 154a of the path along which the sliding platform 130 translates (e.g., slides) along the rail structure 122. As referenced above, the rail structure 122 may be supported by the upright support 124 at discrete elevations, which may be referred to as setting, such as a resistance, elevation, or inclination setting. Thus, the discrete elevation or setting of the exercise machine 110 may be determined from the angle of inclination 154a. For example, different models of the exercise machine may be known to have different numbers and/or location of the elevation settings that correspond to known angles of inclination and may be determined according to the angle of inclination 154a sensed with the inclination sensor 654. Alternatively, the inclination sensor 654 may detect the different elevation settings directly from which the angle of inclination 154a may be determined from the detected setting (e.g., via calculations or a lookup table).

In one example, the inclination sensor 654 may include an accelerometer from which the angle of inclination 154a may be determined directly. For example, with the sensor module 150′ coupled to the sliding platform 130 or the rail structure 122 of the chassis 120, the angle of inclination 154a of the rail structure 122 may be measured directly by the accelerometer.

In another example, the inclination sensor 654 may measure a distance to the ground level (e.g., a floor), such as a by including an emitter and detector pair (e.g., LIDAR or SONAR). Based on the measured height between the inclination sensor 654 and the ground level, as well as other known or sensor information (e.g., the position information), the angle of inclination may be derived from the measured height.

In a still further example, the inclination sensor 654 may be configured to directly detect the elevation setting (i.e., the discrete elevation at which the rail structure 122 is supported by the upright support 124), for example, being an optical sensor that detects optical patterns or a magnetic sensor that detects magnetic patterns on the upright support 124. Based on known geometric information about the exercise machine 110 (e.g., the heights corresponding to each elevation setting) and a length of the rail structure 122, the angle of inclination 154a may be determined from the elevation setting.

### 2.2.5 Other Sensors

### 2.2.5.1 Accelerometer

In the case of the inclination sensor 654 including the accelerometer, or in the case of the sensor system 150 including the other sensors 662 that may otherwise include an accelerometer (e.g., instead of or in addition to the position sensor 652 and/or the inclination sensor 654), the accelerometer may also be used to detect motion, measure motion, or both. For example, relative positions of the sliding platform 130 may be determined from double integrating the acceleration data collected with the accelerometer. However, direct measurements of position with the position sensor 652 may be favorable over accelerometer data due to errors (e.g., in sensing, calculations (e.g., double integrating compounding sensing errors), or both) and/or resultant motion of the sliding platform 130 during particular exercises (e.g., simultaneous alternating arm curls may result in only slight movements and/or exercises in which velocity of the sliding platform 130 is relatively constant). The accelerometer data may also be used in other manners, for example, to determine whether the sliding platform 130 is moving motion (e.g., used to wake other sensors and electronic components of the sensor system 150) or in a stored position (e.g., with the rail structure 122 upright adjacent the upright support 124).

The other sensors 662 of the sensor system 150 may further include one or more force sensors that measure force applied by the user to the exercise machine 110. For example, force sensors may be incorporated into the attachment point at which the cable 140a couples to the sliding platform 130 (e.g., at an upper end), within each of the grips 140b, the stationary platform 122e, or combinations thereof. Instead of force, the amount of resistance may instead be calculated, for example, according to the angle of inclination 154a and a known weight for the use and the sliding platform 130.

The other sensors 662 of the sensor system 150 may include other sensors that detect motion and/or orientation of the user (e.g., hands) and from which valuable information may be determined, for example, the particular or possible exercises that may be performed by the user. For example, the other sensors 662 may include accelerometers and/or gyroscopes in one or both of the two grips 140b of the handle system 140. In this case, the other sensors 662 are configured to measure orientation, changes in orientation, movement, or combinations thereof that may be indicative, alone or in conjunction with the position information detected with the position sensor 652, which may indicate an exercise being performed by the user. For example, steady horizontal and parallel orientation of the hands of the user may indicate performance of a chest press exercise, while steady horizontal orientation and closing angles of the hands of the user may indicate performance of a butterfly press exercise.

In yet another example, the exercise machine 110 may be configured to add weight to the sliding platform 130, for example, by coupling additional weights to an underside of the sliding platform 130. In such case, the other sensors 662 may include weight sensors that are configured to detect and quantify the additional weights coupled to the sliding platform 130. For example, the weight sensors may be capacitive, conductive, or optical for detecting the additional weights. To quantify the amount of added weight, the additional weights may be of a fixed amount, be visually distinguishable from each other by the weight sensors, and/or include other inherent or applied indicators of their respective weights (e.g., visual, magnetic, or capacitive characteristics or applied indicators).

In a still further example, sensors of the wearable device 180, such as a smartwatch or other wearable device, may sense orientation and/or movement of the hand of the user and be used to determine the particular or possible exercises being performed by the user. The wearable device 180 may further include physiological sensors that detect physiological information of the user (e.g., heart rate) that may be used to determine performance of exercises (e.g., elevated heart rate indicating exercises being performed).

Referring again to FIGS. 6 and 8-10, the sensor system 150 may be packaged as a singular sensor module 650′ that may be mounted to the exercise machine 110 in different manners. In the examples shown in FIGS. 8 and 9, the sensor module 650′ is coupled to the sliding platform 130 and moves therewith relative to the rail structure 122. The sensor module 150′ may, for example, be coupled to the sliding platform 130 generally below the base 130a so as to be protected thereby, for example, from physical interference or contact from the user or other objects. Alternatively, as shown in FIG. 10, the sensor module 150′ may instead be coupled to the lower end 122a of the rail structure and be oriented toward the sliding platform 130. Coupling the sensor module 150′ to the chassis 120, which is non-moving, may be advantageous over mounting to the sliding platform 130 by allowing a wired connection (e.g., power supply thereto).

The sensor module 150′ may be coupled to the exercise machine 110 at lower locations, such as a lower end of the sliding platform 130 (as shown in FIG. 8) or to the chassis 120 proximate the lower end 122a of the rail structure 122 (e.g., below the sliding platform 130). Coupling the sensor module 150′ to such lower locations may be advantageous for different types of the position sensor 652 (e.g., those having the emitter 652a and the detector 652b), so as to prevent visual or other interference (e.g., hair of the user dangling downward and interfering with the light emitted by the position sensor 652).

Referring to FIGS. 8A and 8B, the sensor module 650′ is configured to mount to an underside of the sliding platform 130, for example, to the base 130a or a frame (not shown) thereunder. A common sensor module 650′ may be configured to be used with different models of the exercise machine 110, which may have different geometries. For example, one model of the exercise machine 110 may include the lower end 122a of the rail structure 122 to which the reflector 852c is coupled at one elevation relative to the underside of the base 130a, while another model of the exercise machine may include the lower end 122a of the rail structure 122 at another lower elevation relative to the underside of the base 130a. With the one model of the exercise machine 110, the sensor module 650′ may be mounted with an upper surface thereof directly contacting a lower surface of the sliding platform 130 (e.g., the base 130a or the frame). With the other model of the exercise machine 110, the sensor system 150 may be provided as a retrofit kit that further includes a shim 851 that spaces the sensor module 650′ further away from the sliding platform 130, changes an angle of the sensor module 650′ relative to the sliding platform 130, or both so as to accommodate the different elevation between the underside of the sliding platform 130 and the chassis 122.

Referring to FIG. 13, the computing system 170 is configured to determine, display, transmit, or combinations thereof exercise information. The computing system 170 may, for example, be a portable computing device, such as a smartphone, tablet computer, smartwatch, laptop computer, desktop computer, or server computer. In one example, the computing system 170 is a personal computing system generally associated with only one of the sensor systems 150 (e.g., of an exercise machine 110 at the home of the user) to receive signals and information therefrom. In another example, the computing system 170 is a public computing system that may be associated with multiple sensor systems 150 of different exercise machines 110 (e.g., at a gym environment) to receive signals and information therefrom.

As shown in FIG. 13, the computing system 170 generally includes a controller 1372, a display 1374, and a communications interface 1376. The controller 1372 is configured to perform various of the operations described herein (e.g., determining various exercise characteristics) and control other components of the computing system 170 (e.g., the display 1374 and the communications interface 1376). The controller 1372 may, for example, have the hardware configuration described for the controller 656 described previously or any other suitable configuration. The display 1374 is configured to visually display information to the user, such as the exercise information. The communications interface 1376 is configured to send, receive, or both signals with various information from the sensor system 150, the wearable device 180, and a personal computing device of the user (discussed below; not shown).

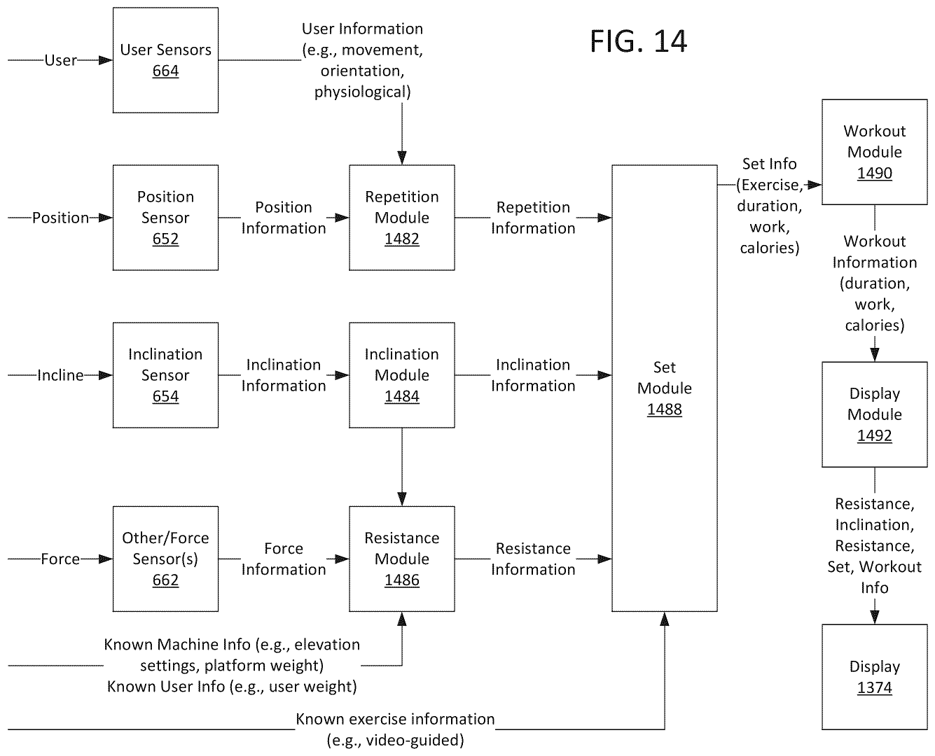

Referring to FIG. 14, a schematic diagram of information collection, flow, and processing performed by the exercise system 100 is illustrated for determining and providing exercise information for the resistance exercises performed by a user. It should be noted that the specific modules described herein are for illustrative purposes and the functions performed thereby may be subdivided, combined, or performed by other components or devices in any suitable manner. Furthermore, while certain information is depicted as flowing from certain modules to other modules in a simplified manner, it should be understood that each module may receive information in any suitable manner from any appropriate device or module. For example, while the information is illustrated as flowing in a step-wise manner from the various sensors to the repetition, inclination, and resistance modules and then to the set module and the workout module, it should be understood that the various information may flow directly or indirectly between the modules (e.g., the set module is discussed below as utilizing position information from the position sensor 652).

Exercise information may relate to a single repetition of an exercise performed by a user, a set of multiple repetitions one particular exercise performed by the user, or a workout during which multiple different sets of one or more exercises are performed by the user. Various of the exercise information may be determined from the sensor information collected with the sensor system 150 alone or in conjunction with other information. Other information may, for example, include known information and sensed information. Other known information may, for example, include the weight of the user, the weight of the sliding platform 130, and a prescribed workout routine (e.g., each exercise and relative times thereof, such as from a workout video that guides users through a series of different known exercises over known time sequences). Other sensed information may include other information sensed with the sensor system 150 (e.g., force, acceleration, and/or orientation information from the other sensors 662) or other sensors associated with the user (e.g., of a wearable device 180 measuring orientation, movement, physiological information (e.g., heart rate) of the user).

The exercise system 100 is configured to determine repetition information, which may include whether a repetition has been performed, the number of repetitions performed in a given set of an exercise, different sets of repetitions that are performed, or combinations thereof. More particularly, the exercise system 100 is configured to determine the repetition information from the position information detected with the position sensor 652. For example, the exercise system 100 may include a repetition module 1482 that counts the number of repetitions performed in a set and may further quantify other characteristics of individual repetitions or a set of repetitions (e.g., distance traveled). The repetition module 1482 includes a set of instructions (e.g., software) that is executed by the exercise system 100, such as the controller 656 of the sensor system 150 or the controller 1372 of the computing system 170.

To determine the repetition information, the repetition module 1482 receives and processes the position information detected with the position sensor 652 to identify movement coincident in time with performance of a repetition or a set of repetitions. The repetition module 1482 may determine that a repetition has been performed according to a change in position over time (i.e., movement) detected by the position sensor 652. For example, a repetition may be determined to have been performed according to movement between a low position and a subsequent high position (e.g., low-to-high movement) detected by the position sensor 652 over a short amount of time (e.g., five, four, three, two seconds or shorter) or within a pattern of movement (e.g., no intermediate low or high positions of greater magnitude). Instead or additionally, a repetition may be determined to have been performed if the magnitude of the low-to-high movement (e.g., a distance) detected with the position sensor 652 is above a general threshold or that of a specific or known exercise (e.g., being performed at a time coinciding with a workout video).

To distinguish repetitions from aberrant movements, such as those that might occur before, during, or after a repetition, the low-to-high movement detected with the position sensor 652 may instead or additionally be evaluated in context with other low-to-high movements. For example, a repetition may be determined to have occurred if the magnitude, duration, or both of one low-to-high movement detected with the position sensor 652 are similar to those of preceding or subsequent low-to-high movements.

The repetition module 1482 may further determine the number of repetitions performed in a set of exercises by counting the number of repetitions performed. To distinguish between different sets of repetitions, the exercise system 100 may identify gaps in time between repetitions performed. For example, the time between repetitions may be compared to a general threshold amount of time (e.g., 30 seconds, more or less) or the time known to be between sets of a specific workout (e.g., a workout video). Instead or additionally, the repetition module 1482 may distinguish between different sets of repetitions based on different characteristics of the repetitions, for example, having different low-to-high movements (e.g., different distances and/or different low and/or high positions).

As referenced above, the determining and counting of repetitions may be performed by the sensor system 150. For example, the controller 656 may include the repetition module 1482 and be configured to determine and count the number of repetitions performed in a set of repetitions according to the position information detected by and received from the position sensor 652 (e.g., in the manner described above). Alternatively, as also reference above, the determining and counting of repetitions may instead be performed by the computing system 170. For example, the controller 1372 may include the repetition module 1482 and be configured to determine and count the number of repetitions according to the position information detected by and received from the position sensor 652.

It is further noted that while the determining of repetitions and counting are described as being performed by the repetition module 1482 on a single computing device, various aspects of the repetition module 1482 may be divided into further modules that may be included with (e.g., performed by) different combinations of computing devices, such as the sensor system 150 determining whether a repetition has been performed, while the computing system 170 counts the number of repetitions.

The exercise system 100 is configured to determine the inclination of the exercise machine 110 during a repetition or a set of repetitions of an exercise performed by the user. More particularly, the exercise system 100 is configured to determine the inclination from the inclination information detected with the inclination sensor 654. For example, the exercise system 100 may include an inclination module 1484 that includes a set of instructions (e.g., software) that is executed by the exercise system 100, such as the controller 656 of the sensor system 150 or the controller 1372 of the computing system 170, to determine the inclination.

To determine the inclination, the inclination module 1484 receives and processes the inclination information received from the inclination sensor 654. In one example, the inclination may be characterized as the angle of inclination 154a that the inclination module 1484 determines to be the angle that is measured by the inclination sensor 654 during performance of a repetition or set of repetitions. Alternatively, the angle of inclination 154a may be determined by the inclination module 1484 from an elevation setting that is detected with the inclination sensor 654 and known geometric information about the exercise machine 110, such as the heights of multiple elevation settings and a length between the lower end 122a and the upper end 122b of the rail structure 122, or a lookup table with angles of inclination for each elevation setting.

In another example, the inclination may be characterized as an elevation setting, which may be expressed numerically (e.g., as one of consecutive numbers assigned to each successive elevation setting) or a height (e.g., elevation measure). The elevation setting may be determined by the inclination module 1484 to be the elevation setting detected by the inclination sensor 654. Alternatively, the elevation setting may be determined by the inclination module according to the angle of inclination 154a measured by the inclination sensor 654 and known geometric information about the exercise machine 110 or a lookup table.

The exercise system 100 may be further configured to determine the resistance of repetitions or sets of repetitions. For example, the exercise system 100 may include a resistance module 1486 that includes a set of instructions (e.g., software) that is executed by the exercise system 100, such as the controller 656 of the sensor system 150 or the controller 1372 of the computing system 170, to determine the resistance.

In one example, the resistance (e.g., the weight lifted by the user) may be determined according to the inclination as determined by the inclination module 1484 (e.g., the angle of inclination 154a or inclination setting) and known weight information that includes the weight of the sliding platform 130 (e.g., a known characteristic of the exercise machine 110) and the weight of the user (e.g., input by the user to the exercise system 100). The weight of the sliding platform 130 may, for example, be stored by the sensor system 150, the computing system 170, or both, for example, being a known value that stored in association with a specific one of the exercise machines 110 or a particular model of the exercise machine 110. The weight of the user may be input to the exercise system 100, for example, being input with a user interface to the computing system 170 or to a personal computing device (not shown) associated with the user (e.g., a personal computing device, such as a personal computer or smartphone) and then sent to the computing system 170. The personal computing device may have a hardware configuration similar to that described for the computing system 170. The resistance module 1486 may, for example, calculate the resistance from the angle of inclination 154a and the weights in a conventional manner (e.g., geometric calculations) or with a lookup table (e.g., a factor to be multiplied by the weights based on the angle of inclination 154a or inclination setting). In such case, the sensor system 150 may include the resistance module 1486 and require that the user weight be provided thereto, or preferably the computing system 170 may include the resistance module 1486 and receive the inclination information from the inclination module 1484 (whether included with the sensor system 150 or the computing system 170).

Alternatively, the resistance may be determined by the resistance module 1486 according to force sensed by the other sensors 662, such as the force sensors described previously. In such case, the sensor system 150 may include the resistance module 1486 or the computing system 170 may include the resistance module 1486.

The exercise system 100 may be further configured to determine various set information, which may quantify or otherwise characterize the set of repetitions and/or exercise performed by the user. The exercise system 100, such as the computing system 170, may include a set module 1488 that determines the other set information. The other set information may, for example, include identification of the exercise performed in the set, duration of the set, work performed, calories burned, or combinations thereof. The exercise being performed may be determined according to the position information (e.g., the distance of repetitions), user information (e.g., orientation and/or movement of the user, such as hands of the user), known exercise information (e.g., exercises of a video guided workout), or combinations thereof. The duration of the set may be determined according to the position information or the repetition information, including time information associated with each set. The work performed may be determined according to the position information and the resistance information (e.g., work being equal to the resistance expressed as force times the cumulative distances of the repetitions). Calories burned may be determined, for example, according to various other information, such as the work performed, number of repetitions of the set, the exercise, physiological information (e.g., heart rate), or combinations thereof.

The exercise system 100 may be further configured to determine various workout information, which may quantify or otherwise characterize the workout (e.g., multiple sets of repetitions and/or exercises performed by the user). The exercise system 100, such as the computing system 170, may include a workout module 1490 that determines the workout information. The workout information may, for example, include duration of the workout (i.e., between the first and final set), cumulative duration of the sets (e.g., the duration of the individual sets added together), work performed, calories burned, or combinations thereof, which may be determined as described previously for the set information.

The exercise system 100 may be further configured to display various information (e.g., repetition, inclination, resistance, set, and workout information) with the display 1374 of the computing system 170 or another display. For example, exercise system 100 may include a display module 1492 configured to cause the display 1374 to display the various information to the user. In some embodiments, such as those at a gym or other public venue, the display module 1492 may be configured to display various information of multiple different users.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An exercise system comprising:
an exercise machine having a chassis that defines an incline and a sliding platform configured to support a user thereon and that translates along the incline, the exercise machine being configured for the user to perform resistance exercises therewith; and
a sensor system having a position sensor that measures a position of the sliding platform relative to the chassis.

2. The exercise system according to claim 1, wherein one of the sensor system or a computer system in communication with the sensor system is configured to determine, according to the position measured by the position sensor over time, a number of repetitions of a set of one of the resistance exercises performed by the user.

3. The exercise system according to claim 2, wherein the position sensor is a LIDAR sensor.

4. The exercise system according to claim 3, wherein the chassis includes a rail structure that defines the incline and that includes a lower end that is configured to be supported by a ground level, and the LIDAR sensor is coupled to the sliding platform and measures the position of the sliding platform by measuring a distance between the LIDAR sensor and the lower end of the rail structure.

5. The exercise system according to claim 1, wherein the position sensor is a LIDAR sensor.

6. The exercise system according to claim 1, wherein inclination of the incline is adjustable relative to gravity, and the sensor system further includes an inclination sensor configured to determine the inclination of the incline.

7. The exercise system according to claim 5, wherein the inclination sensor is an accelerometer.

8. The exercise system according to claim 7, wherein the sensor system includes a sensor system module having a housing containing the position sensor and the inclination sensor.

9. The exercise system according to claim 8, further comprising a computer system that is configured to determine resistance of the resistance exercises performed by the user according to the inclination determined by the inclination sensor, a first weight of the sliding platform, and a second weight of the user.

10. The exercise system according to claim 5, further comprising a computer system that is configured to determine resistance of the resistance exercises performed by the user according to the inclination determined by the inclination sensor, a first weight of the sliding platform, and a second weight of the user.

11. The exercise system according to claim 1, further comprising a computer system that is configured to determine resistance of the resistance exercises performed by the user according to the inclination determined by the inclination sensor and a first weight of the user.

12. The exercise system according to claim 11, wherein the computer system is configured to determine the resistance of the resistance exercises performed by the user according to the inclination determined by the inclination sensor, the first weight of the user, and a second weight of the sliding platform.

13. The exercise system according to claim 1, wherein the sliding platform includes rollers that roll along the incline for the sliding platform to translate along the incline.
